(19) United States
(12) Patent Application Publication
(10) Pub. No.: US 2026/0299665 A1
(43) Pub. Date: Oct. 1, 2026

(54) POWER SOURCE CONTROL DEVICE, POWER SOURCE CONTROL SYSTEM, POWER SOURCE CONTROL METHOD, AND POWER SOURCE CONTROL PROGRAM

(71) Applicant: NTT, INC., Tokyo (JP)

(72) Inventors: Hikaru HARASAWA, Musashino-shi, Tokyo (JP); Shogo SAITO, Musashino-shi, Tokyo (JP); Kei FUJIMOTO, Musashino-shi, Tokyo (JP)

(21) Appl. No.: 18/998,158

(22) PCT Filed: Jul. 27, 2022
(86) PCT No.: PCT/JP2022/029035

§ 371 Date: Jan. 24, 2025

(51) Int. Cl. G06F 1/324

(52) U.S. Cl. CPC G06F 1/324

(57) ABSTRACT

A server includes an accelerator power source supply unit that individually supplies power source to each accelerator, a power saving controller that selects an accelerator to be a target of power control as a target accelerator and selects a power source control method for the target accelerator, and a resource release/power source cutting unit that instructs the accelerator power source supply unit to perform power source control of the target accelerator after no application uses the target accelerator.

### TECHNICAL FIELD

The present invention relates to a power source control device, a power source control system, a power source control method, and a power source control program.

### BACKGROUND ART

A server equipped with both a CPU (general-purpose processor) supporting general-purpose processing and an accelerator (hereinafter may be abbreviated as ACC) specialized for a specific arithmetic operation has been widely used. Such a server improves processing capability by offloading to the accelerator specific arithmetic operation processing from the general-purpose processor on which software operates.

FIG. 11 is a configuration diagram of a server 70.

The server 70 includes a userland 71 that stores an application 74, an OS 72 that stores a device driver 75, and hardware 73. The hardware 73 includes a CPU 76, an accelerator 77, and a power source supply unit 78.

The application 74 is software that operates on the CPU 76 and uses the accelerator 77. The device driver 75 provides the application 74 with a function for using the accelerator 77.

The CPU 76 executes the application 74. The accelerator 77 is an extension card equipped with an arithmetic operation circuit specialized for specific processing.

The power source supply unit 78 supplies power source to the entire server 70.

The power source supply unit 78 achieves power saving of the server 70 by performing power source control not only on the CPU 76 but also on the accelerator 77.

Specific implementation of the power source supply unit 78 is described below.
Non Patent Literature 1 describes Peripheral Component Interconnect Express (PCIe) Hotplug. PCIe Hotplug is a mechanism for hot swap of the accelerator, and is mounted on PCI Express that is a connection interface of the accelerator. By extracting the accelerator from the server, supplying power from the server is cut off, and power saving can be achieved.
·Non Patent Literature 2 describes a mechanism for changing a balance between processing performance and power consumption by changing an operation frequency (clock change) as a power saving mechanism of an accelerator.

### CITATION LIST

### Non Patent Literature

Non Patent Literature 1: The Linux Kernel 4.14.0, “PCI Hotplug Support Library”, [online], [searched on Jul. 12, 2022], the Internet <URL: https://www.kernel.org/doc/html/v4.14/driver-api/pci.html#pci-hotplug-support-library>

Non Patent Literature 2: OPAE LINUX KERNEL DRIVERS, “FPGA Frequency Setting Change Command Guide (Intel OPAE Toolkit) ”, [online], [searched on July 12, 2022], the Internet <URL: https://opae.github.io/latest/docs/fpga_tools/userclk/userclk.html

### SUMMARY OF INVENTION

### Technical Problem

When controlling the power to be supplied to the accelerator, it is necessary to consider requirements described below in addition to the power saving.
Availability: Stable operation even when power saving is performed. For example, when power feeding to the accelerator is stopped, the time during which the service is interrupted, such as a server crash, is the shortest.
Versatility: Control of power supplied to an offload destination accelerator without causing an offload source (device driver and application) to have an individual power source management function for each accelerator.

However, in the conventional art disclosed in such as Non Patent Literatures 1 and 2 described above, a power control means of an accelerator having both availability and versatility is not provided.

In PCIe Hotplug of Non Patent Literature 1, in a case where there is no implementation supporting hot plugging (such as resource release and re-detection) at an offload source, a system may crash due to sudden device disconnection, and availability is not satisfied. On the other hand, even in a case where there is an implementation supporting hot plugging at the offload source, software support specific for each accelerator is required at the offload source, and PCIe Hotplug does not satisfy versatility.

In addition, in the power saving mechanism of Non Patent Literature 2, because a clock control mechanism is required for the accelerator, versatility is not satisfied.

In addition, because the load on the accelerator varies with lapse of time due to traffic variations or the like, it is necessary to conduct a fine power control (when and how much power is supplied) of the accelerator according to a current load status instead of fixedly setting the power control. In general, in a high-load status, it is necessary to increase the power to the accelerator to improve the processing capability of the accelerator.

Therefore, a main object of the present invention is to appropriately control power supplied to hardware of an offload destination while simultaneously satisfying availability of the hardware of the offload destination and versatility in a situation where there is a load variation.

### Solution to Problem

In order to achieve the above object, a power source control device of the present invention includes the feature described below.

The present invention includes: a power source supply unit that individually supplies power source to each accelerator; a controller that selects the accelerator to be a target of power control as a target accelerator and selects a power source control method for the target accelerator based on usage status and load status of each accelerator used by each application; and a control instruction unit that instructs the application using the target accelerator to perform processing of releasing the target accelerator, and instructs the power source supply unit to perform power source control of the target accelerator after no application uses the target accelerator.

### Advantageous Effects of Invention

According to the present invention, it is possible to appropriately control power supplied to hardware of an offload destination while simultaneously satisfying availability of the hardware of the offload destination and versatility in a situation where there is a load variation.

### BRIEF DESCRIPTION OF DRAWINGS

FIG. 1 is a configuration diagram of a server according to an embodiment of the present invention.

FIG. 2 is a configuration diagram of a usage status database according to the embodiment.

FIG. 3 is a configuration diagram of a load status database according to the embodiment.

FIG. 4 is a configuration diagram of a slot power source configuration recording unit according to the embodiment.

FIG. 5 is a flowchart illustrating power saving method selection processing in response to a load according to the embodiment.

FIG. 6 is a flowchart illustrating power saving control processing activated by a power source cutting instruction according to the embodiment.

FIG. 7 is a flowchart illustrating power saving control processing activated by a circuit change instruction or clock change instruction according to the embodiment.

FIG. 8 is a table illustrating a power saving method instructed by an ACC state instruction unit according to the embodiment.

FIG. 9 is a three-dimensional diagram illustrating a box for accommodating a PCI Express extension card as an implementation example of an accelerator power source supply unit according to the embodiment.

FIG. 10 is a hardware configuration diagram of a server according to the embodiment.

FIG. 11 is a configuration diagram of the server according to the embodiment.

### DESCRIPTION OF EMBODIMENTS

Hereinbelow, each example of the present invention is described in detail with reference to the drawings.

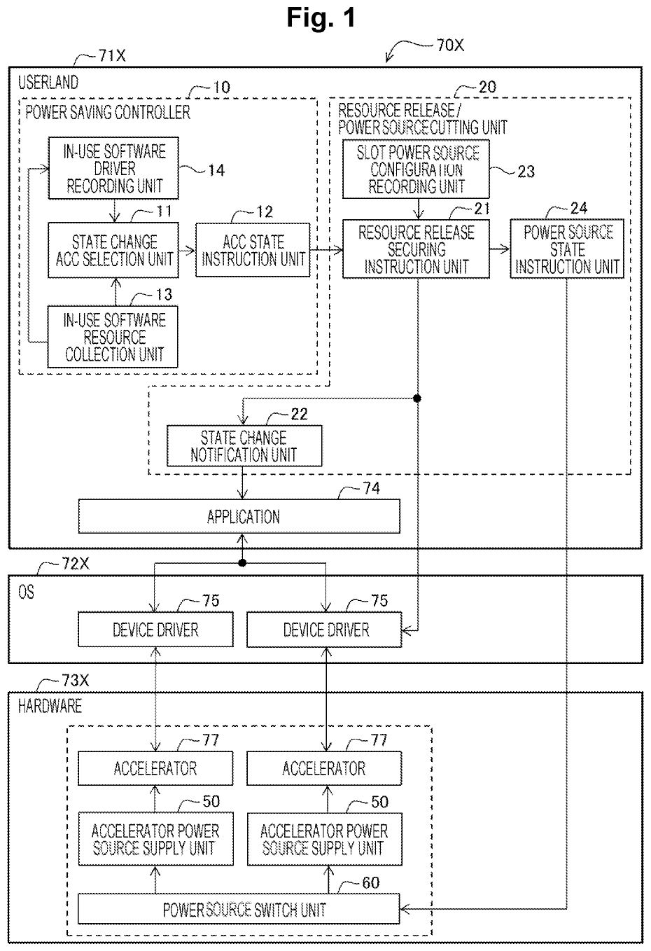

FIG. 1 is a configuration diagram of a server 70X.

The server (power source control device) 70X includes a userland 71X, an OS 72X that stores a device driver 75, and hardware 73X. The userland 71X stores a power saving controller (controller) 10, a resource release/power source cutting unit (control instruction unit) 20, and an application 74.

The application 74 is software that operates on the CPU, and uses an accelerator 77 via the device driver 75. The device driver 75 is software that operates on the CPU. The device driver 75 performs hardware control of the accelerator 77 and provides an interface for use from the application 74.

The hardware 73X includes the accelerator 77, an accelerator power source supply unit (abbreviated as power source supply unit) 50, and a power source switch unit 60.

The accelerator 77 is dedicated hardware that takes over a part of the processing of the application 74. The accelerator 77 receives target data from the application 74, performs some processing, and returns the result to the application 74.

The accelerator power source supply unit 50 individually supplies power source for each slot of the accelerator 77. The power source switch unit 60 performs power source control such as on/off of the power source supplied by the accelerator power source Supply unit 50.

The power saving controller 10 selects the accelerator 77 to be the target of the power control as a target accelerator based on the usage status and the load status of each accelerator 77 used by each application 74, and selects the power source control method for the target accelerator.

Hereinbelow, the accelerator 77 is exemplified as a target of the power control. However, as long as the hardware of the offload destination of the application 74, any hardware device may be the target of the power control, such as a device in the server 70X, or a device connected from outside the server 70X.

Note that instead of the configuration in which the accelerator power source supply unit 50 individually supplies power source for each accelerator 77, a configuration in which power source is individually supplied for each power domain obtained by grouping a plurality of accelerators 77 may be available. In this case, the power saving controller 10 selects a plurality of accelerators 77 simultaneously belonging to the same power domain as target accelerators to be the targets of the power source control.

The power saving controller 10 includes a state change ACC selection unit 11, an ACC state instruction unit 12, an in-use software resource collection unit 13, and an in-use software driver recording unit 14.

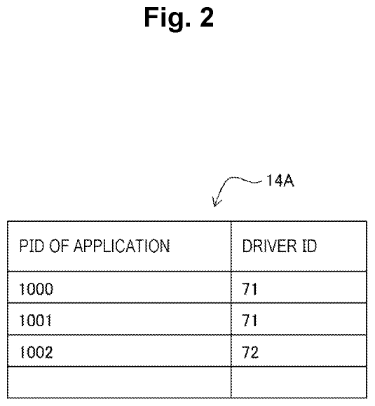

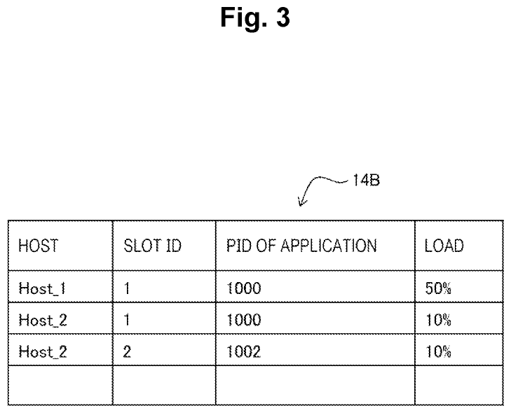

The state change ACC selection unit 11 selects the accelerator 77 for which the power state is changed as the target accelerator based on the information described below.
·The usage status of the accelerator 77 by the application 74 stored in a usage status database 14A of FIG. 2 (combination of accelerator 77 of power source control target and application 74 using accelerator 77).
The load status of the accelerator 77 stored in a load status database 14B of FIG. 3 (processing data amount based on the maximum throughput as a reference).

The in-use software driver recording unit 14 stores the usage status database 14A and the load status database 14B (details is described below). The in-use software driver recording unit 14 stores the usage status and the load status of the accelerator 77 collected from the application 74 in association with an identifier of a slot in which the accelerator 77 used is mounted. Alternatively, a method of linking the slot being used and the process based on the information obtained from the OS 72X or the middleware may be used for the recorded content of the in-use software driver recording unit 14.

The ACC state instruction unit 12 gives an instruction to change the power state of the target accelerator selected by the state change ACC selection unit 11 to a resource release securing instruction unit 21. In addition, the ACC state instruction unit 12 causes a state change notification unit 22 to notify the application 74 that the power source control of the target accelerator is performed, and instructs the state change notification unit 22 to change the power source state.

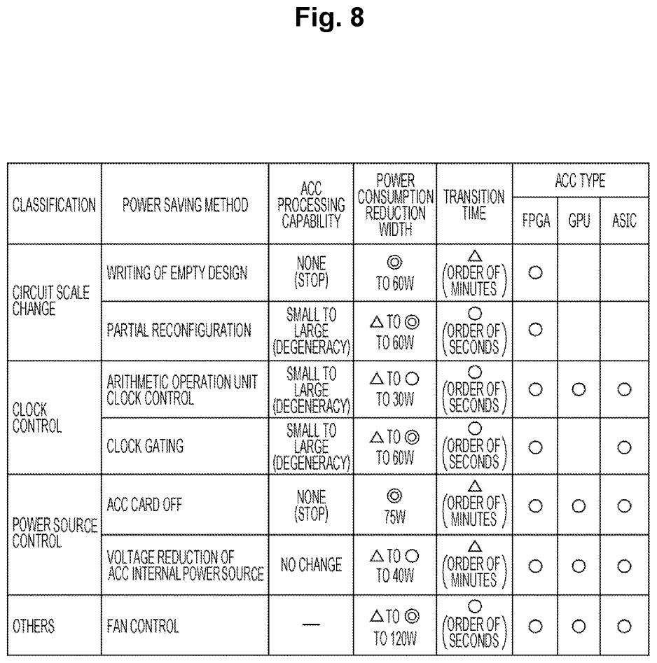

The power source state change instruction content is an instruction to change the accelerator 77 to a various card-dependent low power consumption mode determined based on the content of the in-use software driver recording unit 14, and is, for example, one of the instructions described below (details are illustrated in FIG. 8).
Instruction to turn off the power source of the accelerator 77
Instruction to change the clock of an arithmetic operation unit of the accelerator 77
Instruction to change the FPGA circuit configuration of the accelerator 77.

The ACC state instruction unit 12 is called from the application 74 or called by a method such as periodic execution. Note that a method is conceivable in which the ACC state instruction unit 12 is implemented as a single functional unit with the state change ACC selection unit 11 without being divided therefrom.

The in-use software resource collection unit 13 is activated by a hardware configuration change or a change in the usage status of the accelerator 77 by the application 74, and updates the usage status database 14A that records the usage status of the accelerator 77. In addition, the in-use software resource collection unit 13 collects more detailed information such as power consumption and power efficiency from the OS 72X, the middleware, and the application 74, and updates the load status database 14B with the collection result.

The resource release/power source cutting unit 20 instructs the application 74 using the target accelerator to perform processing of releasing the target accelerator, and instructs the accelerator power source supply unit 50 to perform power source control of the target accelerator after the application 74 using the target accelerator no longer exists. Therefore, the resource release/power source cutting unit 20 includes the resource release securing instruction unit 21, the state change notification unit 22, a slot power source configuration recording unit 23, and a power source state instruction unit 24.

The resource release securing instruction unit 21 executes the following procedures for changing the power source state of the device of the accelerator 77 (hereinafter, abbreviated as the device) according to the instruction (including slot identifier and power saving method) for changing the power state received from the ACC state instruction unit 12.

Procedure 1: Before the power of the device is turned off, notifying the application 74 of the device that becomes unusable by the change in the power source state, and gives an instruction to release the device thereto.

Procedure 2: Confirming whether or not the device driver 75 is used, performs the end processing of the device driver 75, and then cuts off the power source of the accelerator 77. In this case, performs the resource release and the end processing of the device driver 75, and makes a condition in which the target accelerator 77 may be disconnected.

Procedure 3: When restoring the device whose power source has been cut off, performing appropriate processing for associating the device driver 75 with the restored device after the power source is restored. The appropriate processing is, for example, processing of making the target accelerator 77 usable by allocating resources thereto and setting the device driver 75.

In a case where the power source is cut off based on the instruction of the resource release securing instruction unit 21, the state change notification unit 22 notifies the application 74 of the accelerator 77 that becomes unusable at that time point.

With this notification, the application 74 stops using the accelerator 77 and switches to another accelerator 77 or software processing.

Alternatively, the state change notification unit 22 may manage a handler or the like secured by the application 74 and notify the application 74 of a handler that becomes unusable when the accelerator 77 is released. Then, the state change notification unit 22 may return an error when the application 74 tries to use the device after forcible release of the device.

The slot power source configuration recording unit 23 stores, as a slot power source configuration, a correspondence between a power source switch that can be controlled from the outside and a slot whose power source is controlled by the power source switch when the power source switch cannot be opened and closed for each slot. The slot power source configuration recording unit 23 is an optional component that may or may not be included in the resource release/power source cutting unit 20.

Note that the slot power source configuration recording unit 23 may record an identifier that can specifically identify a slot and a power domain to which the slot belongs in association with each other.

Alternatively, the slot power source configuration recording unit 23 may dynamically generate the correspondence between the slot and the power source switch based on in formation from the OS 72X, the device driver 75, other external interfaces, or the like. Further, the slot power source configuration recording unit 23 may store the usage purpose (for always on, for extension when load increases, or the like) of the accelerator 77 simultaneously when storing the slot power source configuration, and prioritize cutting off the power source of the slot in which the accelerator 77 for the extension when load increases is mounted when the power source state is changed.

The power source state instruction unit 24 transmits a command to the power source switch unit 60 to instruct opening/closing of the power source switch of the slot to perform cutoff/restoration of the power source. Note that a device driver 75 that abstracts the operation of the power source switch may be incorporated between the power source state instruction unit 24 and the power source switch unit 60.

The above description explains in order the specific components of the server 70X with reference to FIG. 1. Hereinbelow, three effects obtained from the components of the server 70X is described in order.
Availability: Stable operation even when power saving is performed.
Versatility: Elimination of the need for a specific power source management function for each accelerator.
Power efficiency: Reduction in power consumption of the accelerator.

First, effects of the availability are described.

The in-use software resource collection unit 13 records information of the application 74 using each accelerator 77 and the device driver 75 in the in-use software driver recording unit 14 (usage status database 14A and load status database 14B). The state change ACC selection unit 11 instructs the ACC state instruction unit 12 to release the accelerator 77 based on the usage status recorded in the usage status database 14A.

This makes a state where there is no application 74 that depends on the released accelerator 77, which allows a crash of the application 74 to be prevented even when the power source of the accelerator 77 is cut off (removed). That is, the availability can be satisfied.

Note that hot plugging of a USB device is mounted on a conventional OS 72X. In this hot plugging, in response to a removal instruction from the user, when the USB device is being used, an error is displayed and the user is only notified of the failure of the removal. That is, the conventional technology is intended for safe removal itself, the USB device to be stopped is determined by the user, and the USB device to be resumed is also connected by the user.

On the other hand, the resource release/power source cutting unit 20 of the present embodiment has a feature of notifying the application 74 using the accelerator 77 and autonomously completing the release processing in cooperation with the application 74 when the power saving control of the accelerator 77 occurs.

As a result, by eliminating the need for the removal instruction from the user, a power saving system can be operated transparently in a manner invisible to the user, and the frequency of power source control can be improved.

In addition, the resource release/power source cutting unit 20 of the present embodiment may be provided in the power saving control (for example, turning off the power source) of the accelerator 77 with a resource securing mechanism assuming an operation (for example, restoration of the power source) of returning to the state before the power saving control. The resource securing mechanism records resources (physical address and I/O address) secured by the accelerator 77 before the power saving control, and allocates the same recorded area at the time of return.

Next, the effects of the versatility is described.

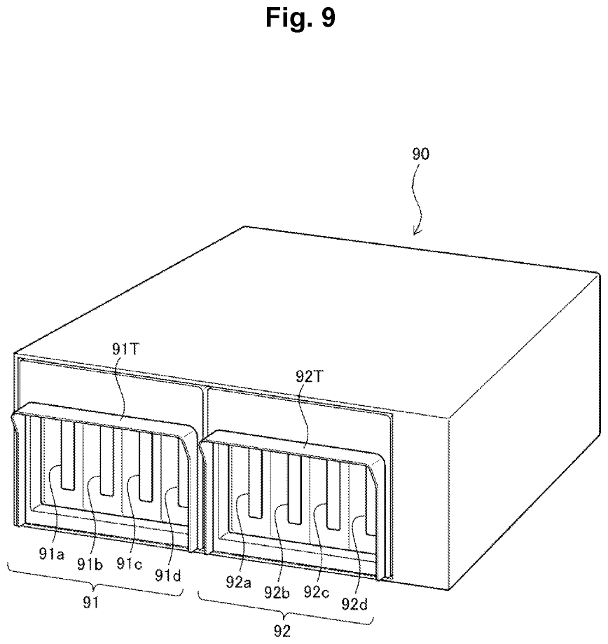

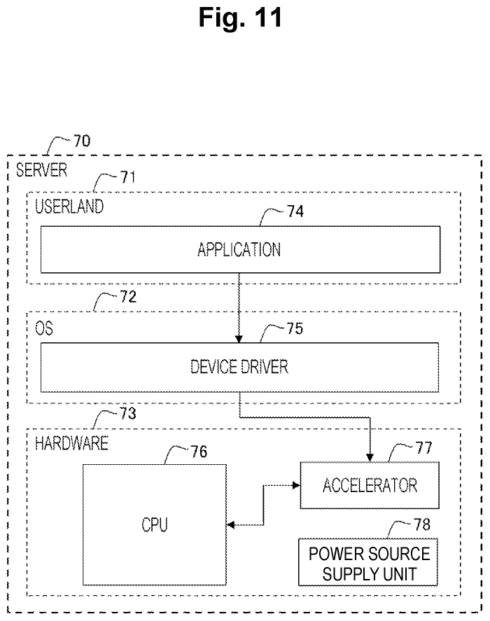

The server 70X of the present embodiment includes a power source control mechanism that makes the accelerator power source supply unit 50 that supplies power source to the accelerator 77 independent on the power source supply unit 78 (FIG. 11) of the server 70X and allows the power source state instruction unit 24 to be capable of individual control (FIG. 9 for details). The accelerator power source supply unit 50 can individually execute power source control of the accelerator 77 from the outside of the device driver 75 or the accelerator 77 without depending on the implementation of the device driver 75 or the implementation of the accelerator 77. The resource release/power source cutting unit 20 instructs the accelerator power source supply unit 50 to perform the power source control.

As a result, even for the accelerator 77 that is not in consideration of hot plugging or does not have a power saving function, the power source can be cut off from the outside without using its specific power source control function, and thus high versatility is secured.

On the other hand, conventionally, the device driver 75 or the accelerator 77 may be implemented to support hot plugging.

However, conventionally, specific software support is required for each individual accelerator 77, and versatility is not satisfied.

Further, the effects of the power efficiency is described.

The state change ACC selection unit 11 executes power source control such as power source cutoff with respect to the unused accelerator 77 selected based on the information of the in-use software driver recording unit 14.

On the other hand, in the conventional power control method, a design method is used in which a clock frequency is changed or power saving is taken into consideration in an FPGA accelerator.

In such power control methods, because the power control is performed while the power source of the accelerator 77 is turned on, the power consumption does not unfailingly become 0 [W], and the effect is limited.

FIG. 2 is a configuration diagram of the usage status database 14A.

The usage status database 14A stores the usage status of the accelerator 77 used by the application 74. The usage status is recorded based on association between a PID (process ID) of the application 74 using the accelerator 77 of the power source control target and an ID of the device driver 75 for using the accelerator 77 of the power source control target.

FIG. 3 is a configuration diagram of the load status database 14B.

The load status database 14B stores the load status of the accelerator 77 used by the application 74. The load status is recorded for each server 70X (host) based on association of the slot ID of the server 70X, the PID of the application 74 executed by the server 70X, and the load of the accelerator 77 offloaded by the application 74.

Note that the value of the load indicates a proportion of the processing target data amount of the server 70X when a maximum throughput is set as a reference (100%). In addition, the processing target data amount (amount of traffic) varies in time series, such as large during the day and small at night.

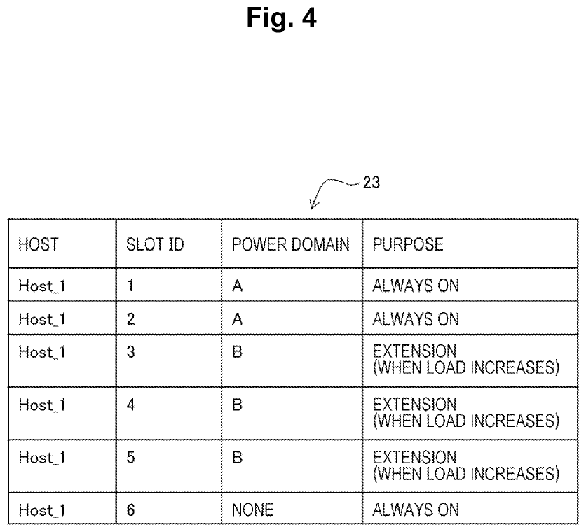

FIG. 4 is a configuration diagram of the slot power source configuration recording unit 23.

The slot power source configuration recording unit 23 records the ID of a slot that is included in each server 70X (host) and accommodates the accelerator 77, a power domain where each slot is formed between another slot, and the purpose of each slot in association with each other.

Note that the power domain indicates a restriction of power source control between slots, and is a unit of power source supply by which turning on and off of the power source can be performed. For example, because slot IDs=1 and 2 of a host (Host 1) belong to the same power domain A, when the power source of the accelerator 77 of the slot ID=1 is turned off, the power source of the accelerator 77 of the slot ID=2 is also turned off at the same time.

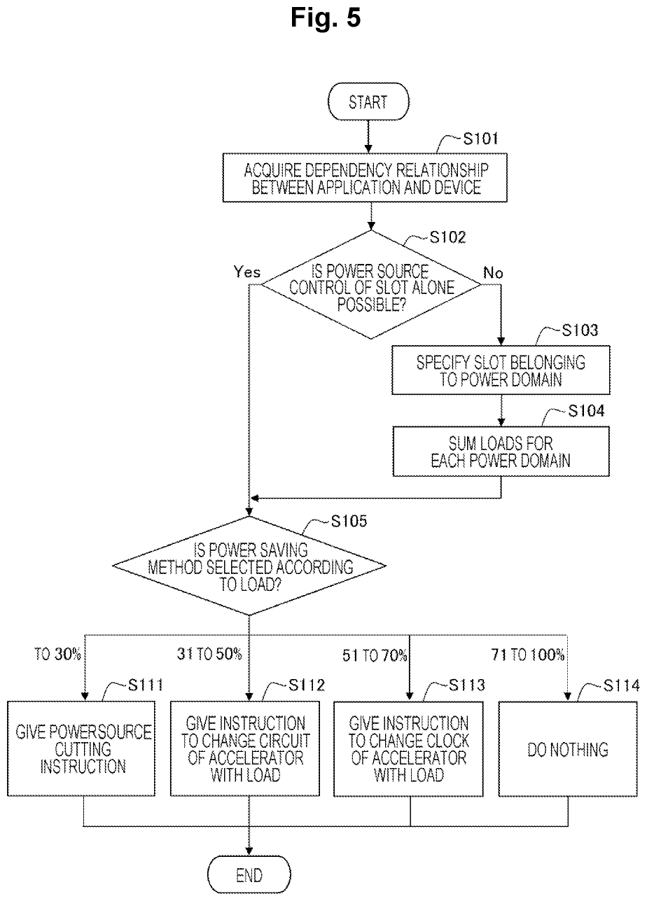

FIG. 5 is a flowchart illustrating power saving method selection processing according to a load. Before executing the processing of FIG. 5, the in-use software resource collection unit 13 collects the load of the accelerator 77 and records the result in the load status database 14B.

The state change ACC selection unit 11 acquires the usage status (dependency relationship with the device) of the application from the usage status database 14A (S101).

The state change ACC selection unit 11 determines whether the power source of the slot of the accelerator 77 used by the application 74 whose usage status is acquired in S101 can be controlled alone (S102). If Yes in S102, the processing proceeds to S105, and if No, the processing proceeds to S103. Note that when the power domain is set in the power source control method, No is selected in S102.

The state change ACC selection unit 11 refers to the slot power source configuration recording unit 23 and specifies the slot belonging to the power domain (S103). The state change ACC selection unit 11 sums the loads of the load status database 14B for each power domain for the slot specified in S103 (S104). This allows the power saving control to be performed even in the server 70X that is restricted in power source control, for example, power source of individual slots cannot be controlled.

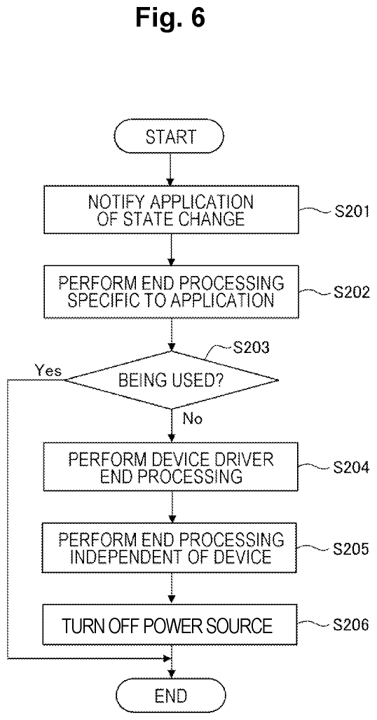

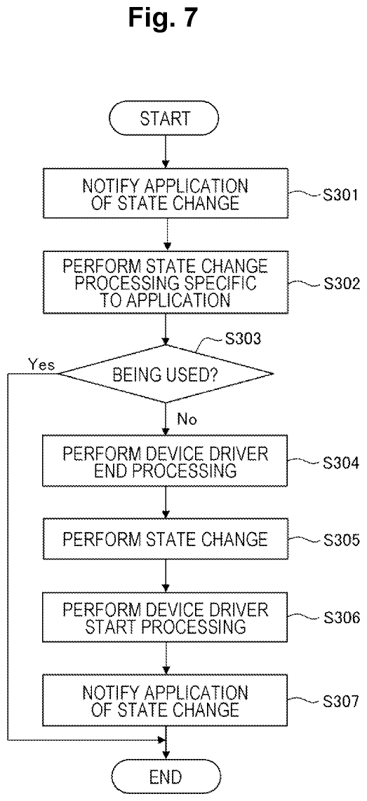

The ACC state instruction unit 12 selects a power saving method to be applied from now on according to the load of the accelerator 77 (S105). Note that the load of the accelerator 77 is a load of a single slot if Yes in S102, and is a load for each power domain summed up in S104 if No in S102.
When load=0%−30%: Power source cutting instruction is given to the resource release securing instruction unit 21 (S111, detailed in FIG. 6).
When load=31%−50%: Instruction to change a circuit of an accelerator with a load is given to the resource release securing instruction unit 21 (S112, detailed in FIG. 7).
When load=51%−70%: Instruction to change a clock of an accelerator with a load is given to the resource release securing instruction unit 21 (S113, detailed in FIG. 7).
When load=71%−100%: Nothing is performed (S114).

The power saving controller 10 selects an optimum power source control method based on the load status of each accelerator 77 (information obtained from the application 74) and characteristics of each power source control method (power reduction effect, transition time to power saving mode, restoration time from power saving mode, or the like). The optimum power source control is, for example, power source control in which the sum of the evaluation point of the power reduction effect and the evaluation point of the processing capability through power supply is the maximum value.

For example, based on the load status of each accelerator 77, the power saving controller 10 selects a power source control method in which the target accelerator with a lower load of the accelerator 77 has a longer transition time and restoration time as in S111 to S114. The policy of the power saving controller 10 is based on the reason described below.

First, the power source control is required to suppress a decrease in performance as much as possible by following a load variation. As a tendency of the power source control, it is assumed that the power source cutting instruction in S111 takes a longer time for transition and restoration than the clock change, such as switching performed in the application 74 or initialization of the accelerator.

Therefore, considering that the load gradually varies, the policy of switching to a method is adopted in which method he lower the load of the accelerator, the longer the restoration time, and the larger the power reduction effect.

FIG. 6 is a flowchart illustrating power saving control processing according to a power source cutting instruction (S111). Upon receiving the power source cutting instruction (S111), the resource release securing instruction unit 21 starts the processing of FIG. 6.

The state change notification unit 22 notifies the application 74 using the accelerator 77 (target accelerator), which is a power source cutting instruction target, of the state change (S201). Therefore, the state change notification unit 22 refers to the in-use software driver recording unit 14 and the slot power source configuration recording unit 23 to specify the application 74, which is a notification destination.

Upon receiving the notification in S201, the application 74 instructs the power source switch unit 60 to perform processing of ending the target accelerator specific to the application 74 (S202). This releases the target accelerator from the application 74.

Note that, when the application 74 executes a task of using the target accelerator before release of the target accelerator, it is desirable to transfer the task to another application 74 (redistribution of the task load). The redistribution of the task load is performed on the application 74 side based on the notification given from the state change notification unit 22 to the application 74.

Here, the resource release securing instruction unit 21 determines whether or not there is an application 74 using the target accelerator (S203). If the end processing of S202 is insufficient and there remains the application 74 using the target accelerator (S203, Yes), the power source cutting instruction of S111 fails because the state change cannot be performed, and the processing is ended.

If No in S203, the resource release securing instruction unit 21 ends the device driver 75 for using the target accelerator (S204). As a result, the instruction from the application 74 to the target accelerator is blocked.

The resource release securing instruction unit 21 instructs the power source state instruction unit 24 to perform the end processing independent of the device of the target accelerator (S205). Upon receiving the instruction in S205, the power source state instruction unit 24 instructs the power source switch unit 60 to turn off the power source of the target accelerator (S206). The accelerator power source supply unit 50 turns off (stops) the power source of the instructed target accelerator.

FIG. 7 is a flowchart illustrating power saving control processing according to the circuit change instruction (S112) or clock change instruction (S113). Upon receiving the circuit change instruction (S112) or the clock change instruction (S113), the resource release securing instruction unit 21 starts the processing of FIG. 7.

S301 to S304 are the same processing as those in S201 to S204 in FIG. 6, and the “target accelerator” is replaced from the accelerator 77 that is a target of the power source cutting instruction (S111) to the accelerator 77 that is an instruction target of the circuit change instruction (S112) or the clock change instruction (S113).

Next, the processing of S304 and S306 assumes a case where it is necessary to temporarily stop the device driver 75 for accessing the target accelerator when the state change of the target accelerator is performed (S305). On the other hand, when the temporary stop of the device driver 75 is unnecessary, the processing of S304 and S306 may be omitted.

The resource release securing instruction unit 21 ends the device driver 75 (S304) and instructs the power source state instruction unit 24 to change the state of the target accelerator (power saving control) (S305). Upon receiving the instruction in S305, the power source state instruction unit 24 instructs the power source switch unit 60 to change the state of the target accelerator. The accelerator power source supply unit 50 executes the state change of the instructed target accelerator.

Then, the resource release securing instruction unit 21 starts the device driver 75 (S306). The state change notification unit 22 notifies the application 74 of the result of the state change with reference to the in-use software driver recording unit 14 and the slot power source configuration recording unit 23 updated by the state change in S305 (S307).

FIG. 8 is a table illustrating a power saving method instructed by the ACC state instruction unit 12.

The ACC state instruction unit 12 is not limited to the power saving method exemplified in S111 to S113, and may execute the power saving method described in the table of FIG. 8.

The table of FIG. 8 associates the processing capability of the ACC (accelerator 77) when the power saving method is applied, the power consumption reduction width (difference from the maximum configuration), the time required for transition and restoration, and the applicability for each ACC (accelerator 77) for each classification of the power saving method and the power saving method.

Note that the power consumption reduction width is a calculated value on the premise of a specific configuration. In addition, the applicability indicates to which accelerator 77 among a field-programmable gate array (FPGA), a graphics processing unit (GPU), and an application specific integrated circuit (ASIC) among accelerators 77 a power saving method is applicable (indicated by a mark “o”).

The four classifications described below are different in fluctuation range of ACC processing capability, power consumption reduction width, time required for transition, and applicability for each ACC. The ACC state instruction unit 12 selectively uses these methods depending on the load prediction result and the type of the control target accelerator 77.

The classification “circuit scale change” includes writing of an empty design and partial reconfiguration (circuit change in S112).

The classification “clock control” includes arithmetic operation unit clock control (clock change in S113) and clock gating.

The classification “power source control” includes ACC card OFF (power source cutting in S111) and voltage reduction of the ACC internal power source.

The classification “others” includes fan control.

FIG. 9 is a three-dimensional diagram illustrating a box 90 (PCIe Box) for accommodating a PCI Express extension card as an implementation example of the accelerator power source supply unit 50.

The box (accelerator accommodation device) 90 may be configured as the same housing as the server 70X or may be configured to be externally connected to the server 70X. The box 90 includes a slot group 91 belonging to a first power domain of an accelerator power source supply unit 51 and a slot group 92 belonging to a second power domain of an accelerator power source supply unit 52.

Four slots: slots 91a to 91d are accommodated in the slot group 91, and the accelerator 77 can be attached to and detached from each slot. Similarly, the slot group 92 accommodates four slots: slots 92a to 92d. In addition, in units of the slot group 91, the slot group 91 can be attached to and detached from the box 90 with a handle 91T, and the slot group 92 can also be attached to and detached from the box 90 with a handle 92T.

Alternatively, the box 90 may be configured to be able to individually control the power source for each slot instead of for each power domain. By using such a box 90, power source control to the accelerator 77 can be performed without performing modification for power source control to the accelerator 77.

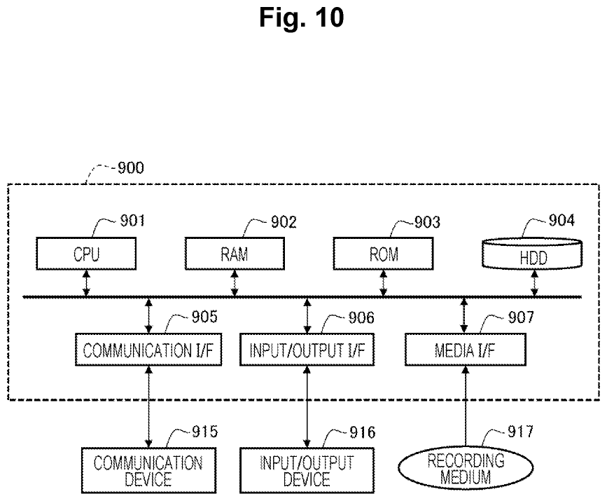

FIG. 10 is a hardware configuration diagram of the server 70X.

Note that the hardware 73X of the server 70X includes the components already described with reference to FIG. 1. Further, FIG. 10 additionally describes components included in the server 70X.

The server 70X is configured as a computer 900 including a CPU 901, RAM 902, ROM 903, an HDD 904, a communication I/F 905, an input/output I/F 906, and a media I/F 907.

The communication I/F 905 is connected to an external communication device 915. The input/output I/F 906 is connected to an input/output device 916. The media I/F 907 reads and writes data from and to a recording medium 917. Further, the CPU 901 controls each unit by executing a program (the application 74 in FIG. 1, also referred to as app for abbreviation thereof) that is read into the RAM 902. Then, the program may be distributed via a communication line or distributed by being recorded in the recording medium 917 such as a CD-ROM.

### [Effects]

The server 70X of the present invention includes the accelerator power source supply unit 50 that individually supplies power source to each accelerator 77,

The power saving controller 10 that selects an accelerator 77 to be a target of the power control as a target accelerator and selects a power source control method for the target accelerator based on the usage status and the load status of each accelerator 77 used by each application 74, and
the resource release/power source cutting unit 20 that instructs the application 74 using the target accelerator to perform processing of releasing the target accelerator, and instructs the accelerator power source supply unit 50 to perform power source control of the target accelerator after no application 74 uses the target accelerator

Note that the accelerator 77 is an example of hardware of an offload destination.

As a result, in the present invention, the accelerator power source supply unit 50 that enables power source control that does not depend on the implementation of each accelerator 77 secures versatility that does not depend on the implementation of the specific accelerator 77.

In addition, because the resource release/power source cutting unit 20 performs the power source control after the application 74 using the target accelerator no longer exists, it is possible to prevent a crash and improve availability.

According to the present invention, instead of the configuration in which the accelerator power source supply unit 50 individually supplies power source to each accelerator 77, the accelerator power source supply unit 50 is configured to individually supply power source to each power domain obtained by grouping the plurality of accelerators 77, and
the power saving controller 10 selects the plurality of accelerators 77 belonging to the same power domain as target accelerators to be targets of the power source control at the same time.

As a result, even in an environment where a configuration in which power source is individually supplied to each accelerator 77 cannot be adopted, a power reduction effect can be expected in units of power domains.

In the present invention, the power saving controller 10 selects an optimum power source control method based on the load status of each accelerator 77 and the characteristics of each power source control method.

As a result, an appropriate power source control method is selected according to the load status in which the varying traffic amount and the capability of each accelerator 77 are reflected, so that both the power reduction effect and the appropriate processing capability can be achieved in a balanced manner.

### REFERENCE SIGNS LIST

10 Power saving controller (controller)
11 State change ACC selection unit
12 ACC state instruction unit
13 In-use software resource collection unit
14 In-use software driver recording unit
14A Usage status database
14B Load status database
20 Resource release/power source cutting unit (control instruction unit)
21 Resource release securing instruction unit
22 State change notification unit
23 Slot power source configuration recording unit
24 Power source state instruction unit
50 Accelerator power source supply unit (power source supply unit)
60 Power source switch unit
70X Server (power source control device)
71X Userland
72X OS
73X Hardware
74 Application
75 Device driver
76 CPU
77 Accelerator
78 Power source supply unit
90 Box (accelerator accommodation device)

1. A power source control device comprising:
a power source supply unit that individually supplies power source to each accelerator;
a controller that selects the accelerator to be a target of power control as a target accelerator and selects a power source control method for the target accelerator based on usage status and load status of each accelerator used by each application; and
a control instruction unit that instructs the application using the target accelerator to perform processing of releasing the target accelerator, and instructs the power source supply unit to perform power source control of the target accelerator after the application using the target accelerator no longer exists.

2. The power source control device according to claim 1, wherein
the power source supply unit is configured to individually supply power source to each power domain obtained by grouping a plurality of the accelerators, instead of a configuration in which the power source supply unit individually supplies power source to each accelerator; and
the controller selects the plurality of the accelerators belonging to a same power domain as the target accelerators to be targets of the power source control simultaneously.

3. The power source control device according to claim 1, wherein the controller selects an optimum power source control method based on the load status of each of the accelerators and characteristics of each of the power source control methods.

4. A power source control device comprising:
a power source supply unit that individually supplies power source to each hardware used as an offload destination by each application;
a controller that selects the hardware to be a target of power control as target hardware based on information obtained from each application and selects a power source control method for the target hardware; and
a control instruction unit that instructs the application using the target hardware to perform processing of releasing the target hardware, and instructs the power source supply unit to perform power source control of the target hardware after the application using the target hardware no longer exists.

5. A power source control system comprising a power source control device and an accelerator accommodation device,
wherein
the accelerator accommodation device includes a power source supply unit that individually supplies power source to each accelerator accommodated by the accelerator accommodation device, and
the power source control device includes:
a controller that selects the accelerator to be a target of power control as a target accelerator and selects a power source control method for the target accelerator based on usage status and load status of each of the accelerators used by each application; and
a control instruction unit that instructs the application using the target accelerator to perform processing of releasing the target accelerator, and instructs the power source supply unit to perform power source control of the target accelerator after the application using the target accelerator no longer exists.

6. A power source control method
implemented by a power source control device including a power source supply unit, a controller, and a control instruction unit,
the method comprising:
supplying power source individually to each accelerator, the supplying executed by the power source supply unit,
selecting the accelerator to be a target of power control as a target accelerator and selecting a power source control method for the target accelerator based on usage status and load status of each accelerator used by each application, the selecting both executed by the controller, and
instructing the application using the target accelerator to perform processing of releasing the target accelerator, and instructing the power source supply unit to perform power source control of the target accelerator after no application uses the target accelerator, the instructing both executed by the control instruction unit.

7. A non-transitory computer-readable storage medium storing a power source control program for causing a computer to function as the power source control device according to claim 6.
